(19) United States
(12) Patent Application Publication
(10) Pub. No.: US 2025/0333025 A1
(43) Pub. Date: Oct. 30, 2025

(54) VEHICLE SENSOR CLEARING WITH SOUND OUTPUT SYSTEM

(71) Applicant: FCA US LLC, Auburn Hills, MI (US)

(72) Inventors: Jason L Vincent, Howell, MI (US); Patrick D Reed, Washington, MI (US); Richard S Silbert, Bingham Farms, MI (US)

(21) Appl. No.: 18/650,813

(22) Filed: Apr. 30, 2024

(51) Int. Cl. B60S 1/56; B08B 7/02

(52) U.S. Cl. CPC B60S 1/56; B08B 7/026

(57) ABSTRACT

A system to clear debris from a vehicle sensor includes a vehicle having a sound system arranged to output sound outside of the vehicle, a sensor mounted on the vehicle and a control system. The control system is coupled to the sound system and includes a processor, and memory communicated with the processor and including one or more programs or instructions that actuate the sound system and are operable to vary the frequency of an output from the audible source, wherein the sound system is arranged to cause vibrations of the sensor.

### FIELD

The present disclosure relates to systems and methods for clearing debris from a vehicle sensor.

### BACKGROUND

Vehicles include sensors, like object detection sensors that emit or take in light, sound or magnetic fields and can thereby determine the presence and/or location of objects within a working range of the sensors. In use of the vehicle, the sensors can get blocked by debris, like dirt, mud, leaves, snow, ice and the like, and this impairs or prevents operation of the sensors.

### SUMMARY

In at least some implementations, a system to clear debris from a vehicle sensor includes a vehicle having a sound system arranged to output sound outside of the vehicle, a sensor mounted on the vehicle and a control system. The control system is coupled to the sound system and includes a processor, and memory communicated with the processor and including one or more programs or instructions that actuate the sound system and are operable to vary the frequency of an output from the audible source, wherein the sound system is arranged to cause vibrations of the sensor.

In at least some implementations, the output sound includes at least one frequency that is outside of a range of sound audible by humans. In at least some implementations, the output sound includes multiple frequencies that are within the range of sound audible by humans.

In at least some implementations, the sound system includes at least one speaker mounted to the vehicle and arranged to provide sound outside of the vehicle. In at least some implementations, the sound system includes multiple speakers spaced apart on the vehicle. In at least some implementations, the programs include instructions to control the output from each of the multiple speakers, wherein the output from each of the multiple speakers is different.

In at least some implementations, the programs include instructions to control the length of a time period in which the sound output is provided.

In at least some implementations, the programs include instructions to control the sound system so that the sound system intermittently provides the output.

In at least some implementations, the programs include instructions to vary the frequency and amplitude of the output within the time period.

In at least some implementations, a method of clearing debris from a vehicle object detection sensor, includes determining that more than a threshold amount of a sensor of a vehicle is blocked by debris, and actuating a sound system to create vibrations at the sensor to remove at least some debris from the sensor.

In at least some implementations, the method also includes, after actuating the sound system for a first period, determining if less than the threshold amount of the sensor is blocked by debris and if not, then actuating the sound system again.

In at least some implementations, actuating the sound system again includes controlling the sound system so that a different frequency of sound is output by the sound system.

In at least some implementations, the sound system is actuated to provide sound output at multiple frequencies, multiple amplitudes or both multiple frequencies and multiple amplitudes during the first period.

In at least some implementations, the sound system is actuated to provide sound output intermittently during the first period.

In at least some implementations, actuating the sound system again includes controlling the sound system so that sound is output from the sound system for a second period that is greater in duration than the first period.

In at least some implementations, the sound system is actuated to provide sound output at multiple frequencies, multiple amplitudes or both multiple frequencies and multiple amplitudes during the second period.

In at least some implementations, the sound system is actuated to provide sound output intermittently during the second period.

In at least some implementations, the sensor is an object detection sensor and is one of a camera, optical sensor, ultrasonic sensor, magnetometer, radar sensor or lidar sensor.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle;

FIG. 2 is a front view of a sensor with debris blocking a majority of a functional surface of the sensor;

FIG. 3 is a view similar to FIG. 2 with the debris removed from the sensor; and

FIG. 4 is a flowchart of a method for clearing debris from a vehicle sensor.

### DETAILED DESCRIPTION

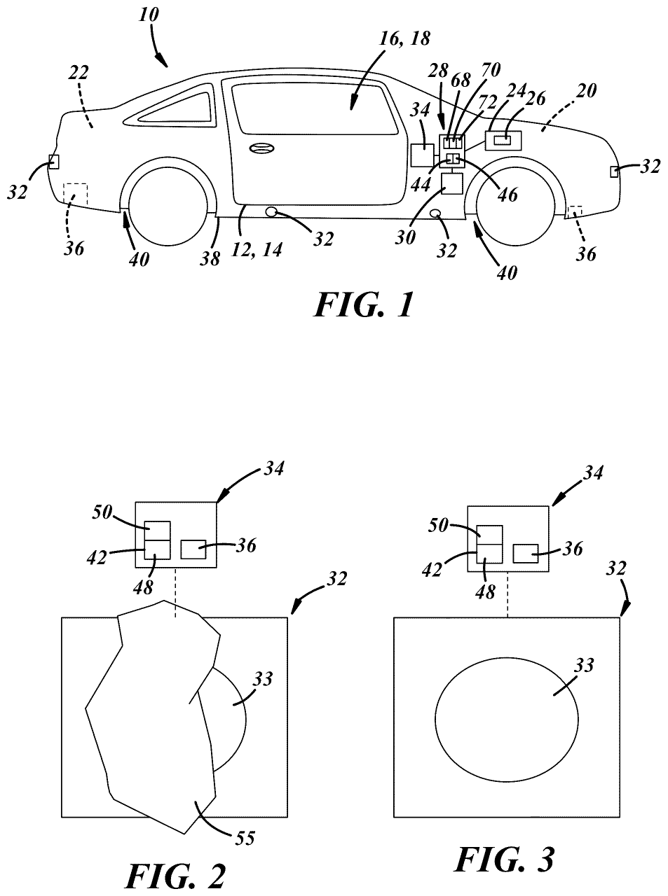

Referring in more detail to the drawings, FIG. 1 shows a vehicle 10 having a body 12 that defines an exterior 14 of the vehicle 10, which is the portion of the vehicle 10 directly visible from outside the vehicle 10, and an interior 16 of the vehicle 10. The interior 16 of the vehicle 10 includes a passenger compartment 18 including seats, and may also include front and rear compartments 20, 22 arranged on either side of the passenger compartment 18 that may be used for storage and to house various systems of the vehicle 10, such as a powertrain 24. The powertrain 24 has one or more prime movers 26 such as an internal combustion engine, an electric motor, or both. The prime mover(s) 26 provide motive force that propels the vehicle 10 along a path of travel, and the prime mover(s) 26 and a wide range of vehicle systems are operated by a control system 28.

Communicated with or part of the control system 28, the vehicle 10 includes multiple sensors 30. The sensors 30 provide a wide range of information to the vehicle control system 28, including but not limited to, vehicle speed, prime mover rotational speed(s), wheel speeds, temperatures, pressures, fuel level, battery level, and more. The sensors 30 may also include one or more object detection sensors 32.

Object detection sensors 32 may use, for example, waves or wave energy like light, sound waves and magnetic fields, to determine the presence of objects in a working range of the object detection sensor 32. Representative types of object detection sensors 32 include cameras, optical sensors, ultrasonic sensors, magnetometers, radar sensors or lidar sensors. These sensors receive or detect light, sound and/or magnetic fields at an input, and may project or emit light or sound or a magnetic field via an output. A camera may include an input having a lens or cover through which light is received and directed onto a suitable sensor to generate an image or image data from which one or more objects may be detected or determined to exist within a field of view of the camera. To detect objects, RADAR, LiDAR, and ultrasonic sensors may emit waves of light or sound from an output and receive at an input some of the waves reflected back from an object in the emission path.

Object detection sensors 32 may be mounted on the vehicle 10 and oriented so that the inputs and/or outputs are open to an area outside the vehicle 10, and not blocked by the vehicle body 12. That is, a line of sight exists from the input and/or output to the environment outside the vehicle body 12. By way of non-limiting examples, object detection sensors 32 may be mounted to trim or body components at the front, rear and sides of the vehicle body 12. In use of the vehicle 10, debris like mud, direct, smoke, snow and ice may accumulate on parts of the vehicle 10. Such debris can accumulate on the functional surfaces 33 of the sensors 32, which may be associated with inputs and/or outputs of the object detection sensors 32, and impair or prevent operation of the object detection sensors 32.

Additionally, certain vehicles operate with little noise detectable from outside the vehicle, such as battery electric vehicles, hydrogen fuel cell electric vehicles, and hybrid vehicles, especially when a combustion engine is not operating. Some of these vehicles include a sound system 34 that provide sound outside the vehicle 10 that is detectable by people outside the vehicle 10 to increase awareness of the vehicle, for example, when the vehicle 10 is traveling at lower speeds. As diagrammatically shown in FIGS. 2 and 3, the sound system 34 may include one or more speakers 36 or other outputs that are mounted outside of the passenger compartment 18 of the vehicle 10 and arranged to provide and direct noise outside of the vehicle 10.

One or more speakers 36 may be mounted to a vehicle structure, generically called or including the vehicle body 12, and have at least a portion that is exposed to the environment outside the vehicle 10, and which may define part of the exterior 14 or an exterior surface of the vehicle 10. Multiple speakers 36 may be provided, with the speakers 36 spaced apart near a periphery of the vehicle exterior 14, perhaps mounted on or near a bottom 38 (FIG. 1) of the vehicle body 12. The speakers 36 may be mounted to the vehicle 10 in any desired location, such as but not limited to, in a wheel well 40 or in or near one of the front and rear compartments 20, 22 of the vehicle 10. Referring again to FIGS. 2 and 3, the speakers 36 are connected to a sound source 42 of the sound system 34 that directs sound signals to the speakers 36 to cause the speakers 36 to emit sound.

The sound source 42 may be connected to and controlled by the control system 28 that may include an infotainment system 44 (FIG. 1) with a user interface 46 that permits control of various vehicle systems and settings. The user interface 46 has suitable inputs (e.g buttons, knobs, touch responsive screens and surfaces) by which passengers may select various menu options to control certain vehicle systems like HVAC, music, information displays, and certain vehicle/preference settings like suspension stiffness, driving mode (e.g. SPORT, ECO, TOUR, TRACK powertrain and/or suspension modes), interact with a connected remote device (e.g. mobile phone), and the like.

The sound source 42 may include a sound signal generator 48 and one or more amplifiers 50 to increase the amplitude of the signals. In at least some implementations, the sound system 34 provides an output of sounds in a frequency range that includes sounds audible, that is, that can be heard by humans, and also sounds outside of the frequency range audible to humans. In at least some implementations, the sound from the sound system 34 may be provided in a range of 5 Hz to 130 kHz, with an example low frequency sound range of 5 Hz to 50 Hz, an example mid-range frequency sound range of 50 Hz to 10 kHz, and an example high frequency sound range of 10 kH to 130 kHz. To inform people near the vehicle 10 of the vehicle's presence, the sound system 34 can, for example, provide sound at a frequency and magnitude audible to humans during times when the noise of vehicle operation is low. Particularly with vehicles driven by electric motors, the output noise from the vehicle can be very low when the vehicle is traveling at low speeds and thus, people might otherwise not hear the vehicle and therefore, not be aware of the vehicle's presence and movement in their area. At higher speeds, noise from the vehicle tires, for example, can be heard and so output noise to alert people might not be needed or useful. Some systems output audible noise that simulates the sounds of a combustion engine, and this may be done to alert people of the vehicle's presence, or for the pleasure/satisfaction of the driver and others.

In at least some implementations, the sound source 42 also drives the speakers 36 to output sound that is outside of the frequency range that is audible/heard by humans. The output sound may be near a lower range of frequencies audible to humans or below the frequency range audible/heard by humans and designed to vibrate one or more of the object detection sensors 32 directly or via vibrations transmitted thereto through one or more structural members of the vehicle 10.

In use of the vehicle 10, the object detection sensors 32, and the functional surface(s) 33 thereof, might become at least partially blocked by debris. As used herein, the term “debris” is intended to have a broad meaning and includes dirt, mud, ice, snow, and other items and fragments of things that may temporarily collect or become in contact with a surface of the object detection sensors 32, particularly a surface or surfaces 33 that when covered at least partially by debris interferes with an output and/or input of the sensors and affects or prevents operation of the sensors 32. To clear debris from at least part of an object detection sensor 32 without requiring direct, manual removal of the debris, the systems and methods herein use the sound system 34 and vibrations generated thereby.

FIG. 2 shows a flowchart of a method 52 that may be used in at least some implementations of the system. The method begins at step 54 in which it is determined if at least part of an object detection sensor 32 is blocked. This may be initiated when the sensor 32 is not operating correctly as determined from the control system 28 or other system communicated with the object detection sensor 32. In at least some implementations, this does not require total blockage and complete inoperability of the sensor 32 but at least some threshold blockage level resulting in a decreased or perhaps unreliable operation and output from the sensor. This threshold blockage may vary depending on the type of blockage in the blocked area (e.g. in an area of the blockage, can light, sound, etc, travel through the blockage at all) and the type of sensor, and can be part of an algorithm or control scheme. For example, a system or controller that uses information from the object detection sensor 32 may determine that a fault exists with the object detection sensor 32 and that may initiate a method, step or program that determines if at least a first threshold amount of the sensor 32 is blocked, by debris or otherwise. A blocked functional surface 33 of a sensor 32 is shown in FIG. 2, where debris 55 is on and covers most of the functional surface 33.

When the sensor is determined to be blocked, the method proceeds to step 56 in which the sound system 34 is actuated for a first time period. The sound system 34 may cause sound at one or more frequencies, and one or more magnitudes to be emitted from one or more speakers 36 during the first time period. In at least some implementations, the frequency(ies) and magnitude(s) are selected to be outside of a range audible to humans to limit or prevent detection by humans. However, other frequencies and magnitudes may be used, if desired. Further, the sound could be provided intermittently and need not be continuous for the entire first time period, as desired.

Additionally, the location of the object detection sensor 32 that is determined to be blocked can be known by the control system 28 and this information can be used to create a desired vibration of that object detection sensor 32. This may be done by driving all or less than all of the speakers 36, for example, only speakers 36 near enough to the sensor might be driven in some implementations. Further, each speaker 36 need not be driven at the same magnitude or frequency, and instead, variable outputs can be provided among the speakers 36 to provide a desired effect at the object detection sensor 32 to be cleared.

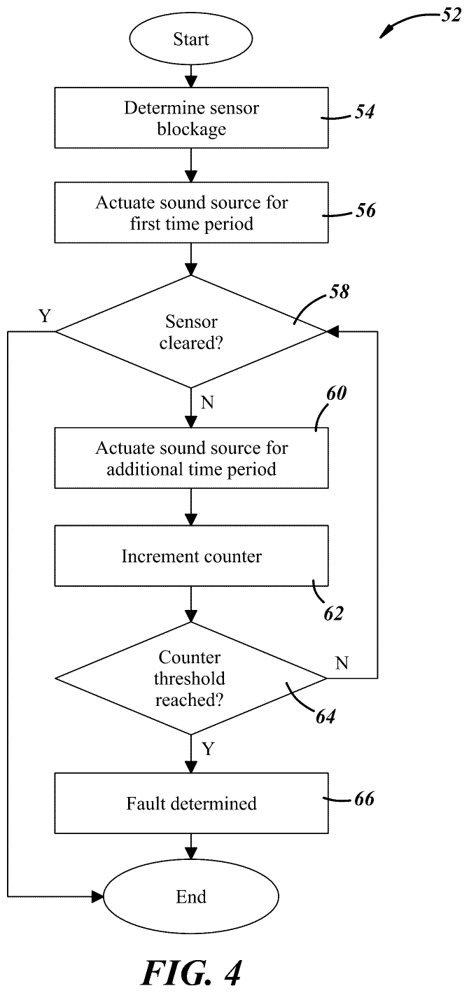

After the first period, the method continues to step 58 in which it is determined if the sensor has been fully or sufficiently cleared. In at least some implementations this determination may be positively made if a second threshold amount of the sensor 32 is clear and capable of operation sufficient for the purpose(s) for which the sensor 32 is used in vehicle system(s). The second threshold amount may be the same as the first threshold amount or different, as desired. In the example of FIG. 3, the debris 55 from FIG. 2 has been cleared and in that example, the method 52 would end, as shown in FIG. 4 after a positive determination in step 58.

If the sensor 32 is not cleared or sufficiently cleared, then the method continues to step 60 in which the sound system 34 is actuated for an additional time period. This actuation of the sound system 34 could be done in the same way as the prior actuation of step 56, including at the same frequency(ies), magnitude(s) and duration (e.g. for the same length of time as the first time period). Or this actuation could be done with one or more different frequencies, one or more different magnitudes and for a different time period. If intermittent sound is output, the intervals of sound can be the same as in step 56, or different, as desired. For example, the additional actuation could be done to seek a greater magnitude of vibrations at or of the object detection sensor 32 than in step 56. This could be achieved, for example, at a greater magnitude and a lower frequency, and/or for a greater duration and perhaps with less to no intervals without sound, as desired.

After the additional actuation of the sound system 34, the method continues to step 62 in which a counter is incremented, and then to step 64 in which it is determined if a counter threshold has been reached. The counter threshold may be set to permit a desired number of iterations of additional sound system 34 actuations, and to allow the method to end after such number of iterations. Thus, if the counter threshold has not been reached, the method returns to step 58 to determine if the sensor is clear. Each additional actuation may be controlled in a different manner with regard to all variables (e.g. time period, frequency(ies), magnitude(s), interval(s)), or in the same manner, as desired.

When the counter threshold is reached, the method continues to step 66 in which a fault is determined, and then the method ends. The fault determination may be communicated to the control system 28 which may provide an alert to an occupant of the vehicle 10 or otherwise. The alert may advise the occupant to clean or clear the sensor, and be provided via the infotainment system, such as by a warning or message on a display of the infotainment system, vehicle instrument cluster or elsewhere. The alert could also be provided to a registered mobile device via a vehicle software application, if desired.

The method may be actuated by a user in response to a vehicle alert that a sensor is blocked, or the method may be automatically implemented by the control system 28. The system facilitates clearing sensors, like object detection sensors 32 without requiring manual clearing or cleaning or a sensor surface. Advantageously, in at least some implementations, the sound system 34 is used not only for clearing the sensor(s) but also for other purposes, such as to emit sound and alert people to the presence of the vehicle 10.

As shown in FIG. 1, the vehicle control system 28 is connected to or communicated with the sound system 34 and the object detection sensors 32. In order to perform the functions and desired processing set forth herein, as well as the computations therefore, the vehicle control system 28 may include, but is not limited to, one or more controller(s), processor(s), computer(s) (generally referred to at 68), DSP(s), memory 70, storage, register(s), timing, interrupt(s), communication interface(s), and input/output signal interfaces, and the like, as well as combinations comprising at least one of the foregoing. For example, the control system 28 may include input signal processing and filtering to enable accurate sampling and conversion or acquisitions of such signals from communications interfaces and sensors. As used herein the term control system 28 may refer to one or more processing circuits such as an application specific integrated circuit (ASIC), an electronic circuit, a processor (shared, dedicated, or group) and memory that executes one or more sets of instructions/software or firmware programs, a combinational logic circuit, and/or other suitable components that provide the described functionality. The control system 28 may be distributed among different vehicle modules, such as an infotainment control module, engine control module or unit, powertrain control module, transmission control module, and the like.

The term “memory” 70 or “storage” or the like, as used herein, can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device. The instructions for the methods and systems described may be part of one or more software programs 72 or applications or other code, to provide the functions and options noted herein.

What is claimed is:

1. A system to clear debris from a vehicle sensor, comprising:
a vehicle having a sound system arranged to output sound outside of the vehicle;
a sensor mounted on the vehicle; and
a control system coupled to the sound system and including a processor, and memory communicated with the processor and including one or more programs or instructions that actuate the sound system and are operable to vary the frequency of an output from the audible source, wherein the sound system is arranged to cause vibrations of the sensor.

2. The system of claim 1 wherein the output sound includes at least one frequency that is outside of a range of sound audible by humans.

3. The system of claim 2 wherein the output sound includes multiple frequencies that are within the range of sound audible by humans.

4. The system of claim 1 wherein the sound system includes at least one speaker mounted to the vehicle and arranged to provide sound outside of the vehicle.

5. The system of claim 4 wherein the sound system includes multiple speakers spaced apart on the vehicle.

6. The system of claim 5 wherein the programs include instructions to control the output from each of the multiple speakers, wherein the output from each of the multiple speakers is different.

7. The system of claim 1 wherein the programs include instructions to control the length of a time period in which the sound output is provided.

8. The system of claim 1 wherein the programs include instructions to control the sound system so that the sound system intermittently provides the output.

9. The system of claim 7 wherein the programs include instructions to vary the frequency and amplitude of the output within the time period.

10. The system of claim 1 wherein the sensor is an object detection sensor and is one of a camera, optical sensor, ultrasonic sensor, magnetometer, radar sensor or lidar sensor.

11. A method of clearing debris from a vehicle object detection sensor, comprising:
determining that more than a threshold amount of a sensor of a vehicle is blocked by debris; and
actuating a sound system to create vibrations at the sensor to remove at least some debris from the sensor.

12. The method of claim 11 which also includes, after actuating the sound system for a first period, determining if less than the threshold amount of the sensor is blocked by debris and if not, then actuating the sound system again.

13. The method of claim 12 wherein actuating the sound system again includes controlling the sound system so that a different frequency of sound is output by the sound system.

14. The method of claim 11 wherein the sound system is actuated to provide sound output at multiple frequencies, multiple amplitudes or both multiple frequencies and multiple amplitudes during the first period.

15. The method of claim 11 wherein the sound system is actuated to provide sound output intermittently during the first period.

16. The method of claim 12 wherein actuating the sound system again includes controlling the sound system so that sound is output from the sound system for a second period that is greater in duration than the first period.

17. The method of claim 16 wherein the sound system is actuated to provide sound output at multiple frequencies, multiple amplitudes or both multiple frequencies and multiple amplitudes during the second period.

18. The method of claim 16 wherein the sound system is actuated to provide sound output intermittently during the second period.

19. The method of claim 11 wherein the sensor is an object detection sensor and is one of a camera, optical sensor, ultrasonic sensor, magnetometer, radar sensor or lidar sensor.
